(19) United States
(12) Patent Application Publication
(10) Pub. No.: US 2006/0176887 A1
(43) Pub. Date: Aug. 10, 2006

(54) SYSTEMS, METHODS AND DEVICES FOR RELAYING COMMUNICATIONS BETWEEN NETWORK DEVICES

(75) Inventors: Donald T. Fair, Reston, VA (US); Eric B. Cole, Leesburg, VA (US); Evan M. Teran, Alexandria, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 11/160,471

(22) Filed: Jun. 24, 2005

Related U.S. Application Data
(62) Division of application No. 10/906,144, filed on Feb. 4, 2005.

(51) Int. Cl. H04J 3/16; H04L 12/28; H04L 12/56; H04J 3/22

(52) U.S. Cl. 370/401; 370/469

(57) ABSTRACT

Provided are systems, devices and methods pertaining to the relaying of communications between a launch computer and a target computer in a manner which obscures at least the launch computer as a participant in the communications. Outbound traffic from the launch follows an outbound relay route which includes at least one intermediary relay computer, while reply traffic from the target computer follows a return relay route also including at least one intermediary relay computer. The outbound and return routes may be either the same or different, and one or more of the intermediary computer(s) may be kept unwitting of their role in the communications.

### BACKGROUND

1) Field of the Invention

The present invention broadly relates to the relaying of communications between devices on a network. More particularly, the invention concerns the relaying of packets between a target computer from a launch computer via predetermined relay routes therebetween. To this end, systems, devices and methodologies are provided.

2) Discussion of Related Art

Since its inception in the 1960's as a packet-switched network, the Internet has grown exponentially into a robust, global network connecting millions of computers. Because the Internet provides fast, inexpensive access to information in revolutionary ways, it has emerged from relative obscurity to international prominence. The Internet itself comprises thousands of interconnected computer networks which are able to share information. These individual networks may be of a variety of types, such as local area networks (LANs) and wide-area networks (WANs), to name a few, and may be categorized by various characteristics including topology, communication protocols and network architecture.

The computers throughout the Internet's infrastructure generate information which is put into packets destined for other computers. The packets can be routed through different computers to arrive at their destination and, over time, various protocols have been designed to allow machines to have guaranteed connections with one another to ensure continued data streams. The ability to route traffic through one or more network communications devices is not new and it is known to relay traffic along the Internet through dedicated routes, for example, to create a virtual private network(VPN). In such situations the identities of the various participants in the relay routing, i.e. the computers themselves, can be readily accessible and not concealed. However, there are situations in which it might be desirable to obscure the identities of at least some of the participants This may be desirable, for example, for administrators and employers desiring to monitor computer-related activities of others, or for the remote installation and roll out of new applications, to name only a few possible applications.

### BRIEF SUMMARY

One embodiment of a relay system described herein comprises first and second network communications devices (NCDs) and a relay subnet that includes at least one intermediary network communications device, each of which is adapted to communicate according to a layered communications protocol. The first NCD issues a data request to the second NCD along a predetermined first relay route between them, while the second NCD transmits a reply to the data request along a predetermined second relay route.

The first and second relay routes are defined by a relay subnet which includes the intermediary NCD. This intermediary is configured to forward outbound traffic corresponding to the data request to the second NCD without revealing the first NCD as the originator of the request. Instead, the intermediary device is identified as the originator from the perspective of the second NCD. The intermediary is also configured to forward inbound traffic corresponding to the reply toward the first NCD.

The data request from the first device to the second device is preferably transmitted within an outbound relay packet which contains outbound routing information, while the reply is transmitted within a reply relay packet containing return routing information. Advantageously, traffic derived from the data request which arrives at the intermediary device, whether traveling in the outbound direction or the return direction, is forwarded without being passed entirely up the intermediary device's protocol stack—that is, it is not normally processed by the stack. It is instead intercepted such that the traffic never reaches upper layers within the stack. As such the intermediary device's operating system (OS), and presumable also its user, can be considered unwitting of the traffic's existence. The second NCD is also considered to be unwitting, but is instead unwitting of the true source of the traffic as opposed to its existence.

Provided also is an NCD configured for use as a participant in a relaying system, such as discussed above. The NCD comprises a memory, a storage device, an I/O system and a processor. The memory stores an operating system (OS) allowing the device to communicate with other computers on a relay network comprising outbound and return relay subnets. The I/O system includes a network adapter for interfacing the NCD to the relay network. The processor is programmed to allow outbound and inbound packets which are not involved in the relaying system to be normally processed by the protocol stack. However, with respect to each outgoing packet which corresponds to a data request destined for the target computer, the processor is programmed to incorporate into the outgoing packet associated outbound routing information during processing by the protocol stack. Further, for those inbound packets which arrive from a relay computer along the return relay subnet, the processor converts them, during processing by the protocol stack, into respective inbound packets corresponding to a reply transmission from the target computer.

Methods are also described for transmitting data between computers. According to one embodiment, an outbound transmission packet is sent from a launch computer toward a target computer along an outbound relay route which includes at least one intermediary computer. A modified outbound transmission packet is received by the target computer which does not identify the launch computer as the packet's origin. A reply transmission packet is then sent from the target computer to the intermediary computer, whereby the reply packet is converted by the intermediary computer into a modified reply transmission packet and forwarded to the launch computer along a return relay route.

These and other objects will become more readily appreciated and understood from a consideration of the following detailed description of the exemplary embodiments when taken together with the accompanying drawings, in which:

### BRIEF DESCRIPTION OF THE DRAWINGS

FIG. 1 is a diagrammatic view representing an exemplary embodiment of a relay system according to the invention;

FIG. 2 is a representative deployment diagram for the relay system of FIG. 1;

FIG. 3 represents a high level flowchart for a methodology which implements the functions of the relay system;

FIG. 4 represents an exemplary network communications device that may be configured to implement aspects of the present invention;

FIG. 5a is a diagrammatic view showing presence of outbound and return relay packets for a representative system incorporating a plurality of relay computers;

FIG. 5b is a diagrammatic view showing presence of outbound and return relay packets for a representative system incorporating a single relay computer;

FIG. 6 is a packet transition diagram showing the various stages assumed by outbound and return relay derived packets within the relay network;

FIG. 7 is a diagrammatic view showing the functional placement of a relay module when installed within an outgoing protocol stack;

FIG. 8a is a diagrammatic representation of a portion of a relay packet's header structure;

FIG. 8b is a diagrammatic representation of an address portion for a relay packet's header structure;

FIG. 9a is a diagrammatic representation showing one approach for encapsulating a relay packet header within a transmission packet;

FIG. 9b is a diagrammatic representation showing another approach for encapsulating a relay packet header within a transmission packet;

FIG. 10a represents a decision-making flowchart on the outgoing protocol stack of the launch computer;

FIG. 10b represents a decision-making flowchart for incoming packets arriving at the launch computer;

FIG. 11 is a diagrammatic view showing the functional interaction of the relay module on the protocol stack of a relay computer which is not a terminal outbound or terminal return relay computer;

FIG. 12 is a decision making flowchart for a terminal outbound or terminal return relay computer;

FIG. 13a is a packet state diagram for outbound and return relay packets as they are transmitted through a relay network having a common pair of outbound and return relay computers, such as shown in FIG. 5a; and

FIG. 13b is a packet state diagram for outbound and return relay packets as they are transmitted through a relay network having a single relay computer, such as shown in FIG. 5b.

### DETAILED DESCRIPTION

An approach is described for relaying communications through one or more distinct routes, preferably without revealing all of the actual participants in the communication. Various terms are used throughout the description and the claims which should have conventional meanings to those with a pertinent understanding of computer systems and programming in general, and more particularly network administration. While the description to follow may entail terminology which is perhaps tailored to certain operating system platforms or programming environments, the ordinarily skilled artisan will appreciate that such terminology is employed in a descriptive sense and not for limiting the invention.

In preferred embodiments launch and target computer systems communicate via predetermined relay routes along a network infrastructure, such as the Internet. The various nodes along the way, and the target system, may be kept unwitting of their role in the communications through the use of loadable kernel modules which obscure or hide relay-related information. Surreptitious relay of communications may be desirable, for example, to permit administrators and employers to monitor computer-related activities of others (e.g. employees or contractors), or for the remote installation and roll out of new applications. These represent only a few possible applications. As will be described, since the kernel modules pull packets from the normal TCP stack as they enter the systems, sniffers running on those machines do not receive the packets, nor do they see the packets that are exiting the system. This allows the relay capability to be hidden from the various participants.

By way of introduction, FIG. 1 shows a relay system 10 for accomplishing these aspects. Here, system 10 includes a first network communications device (1^{st} NCD) functioning as a launch computer 12, a second network device (2^{nd} NCD) functioning as a target computer 14, and a relay subnet 16. In system 10, launch computer 12 can initiate a communication (e.g. by issuing a data request) to the target computer 14 along a predetermined first relay route defined by relay subnet 16. Target computer 14 can then reply along a predetermined second relay route also defined by the relay subnet 10. The relay subnet 10 may include one or more intermediary NCDs and is configured to forward outbound traffic (arrows “A”) corresponding to the data request to target computer 14 in a manner which does not reveal the launch computer 12 as the origin of the data request, as will be described in more detail below. Reply traffic (return arrows “B”) from target computer 14 toward the launch computer 12 also passes through relay subnet 10 which serves to forward the reply. To accomplish the functionalities for system 10, launch computer 12 has an associated relay launch module, the target computer 16 has an optional target relay module 15, while each intermediary computer within the relay subnet 40 preferably has its own relay hop module, collectively 17.

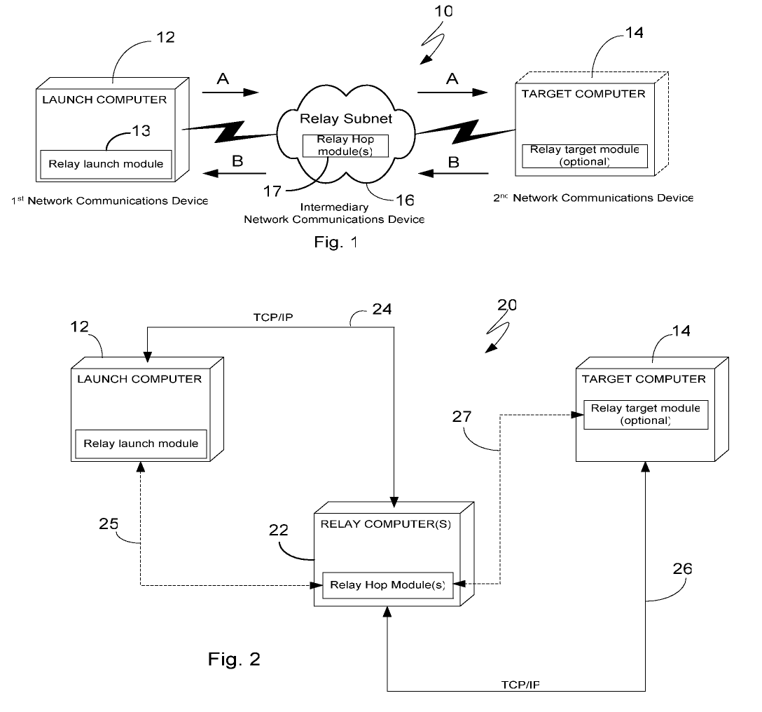

A deployment diagram 20 for the system 10 of FIG. 1 is shown in FIG. 2. Here, it may be seen that launch computer 12, relay computer(s) (generally 22), and the target computer 14 communicate over communication links 24 and 26, preferably in accordance with the TCP/IP suite of protocols as well known in the art. The communication links 24 and 26 can be any suitable type(s) and configuration(s) in relation to the hardware, software, protocols and access methods applied in the design of the network architectures, without limitation. The logical software interactions between the various relay modules are shown by dashed lines 25 and 27.

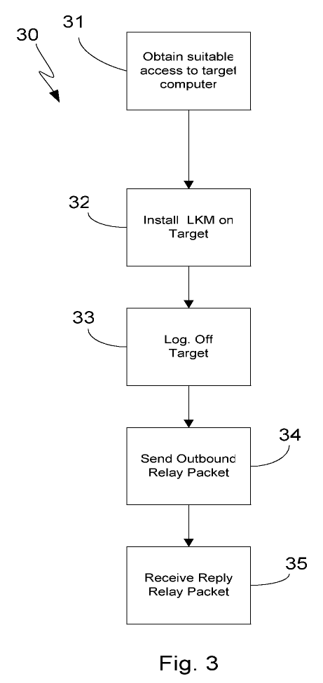

FIG. 3 shows a high level flow diagram 30 for implementing the functions of a relaying system. The target computer is accessed at 31, after which an LKM is installed on it at 32. After logging off at 33, an outbound relay packet is sent at 34 which contains the data request. The outbound relay packet is preferably sent along a predetermined outbound relay route from the launch computer to the target computer. At 35, a reply relay packet is received from the target computer in response to the outbound transmission packet. This reply relay packet is preferably one which traveled along a predetermined return relay route from the target computer to the launch computer.

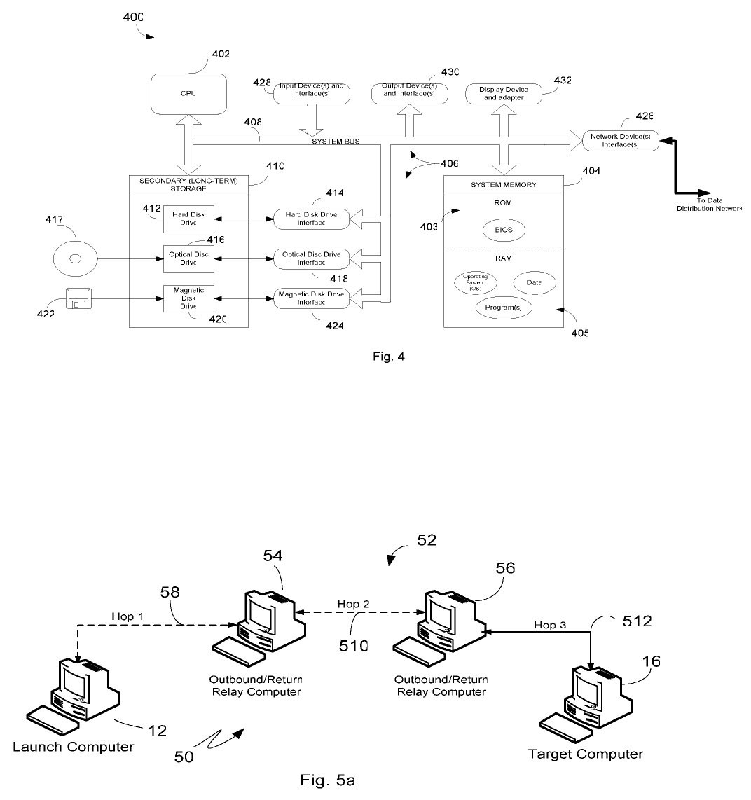

Each network communications device involved in the system is considered to be a participant which may be configured as a general purpose computer system 400 such as representatively depicted in FIG. 4. System 400 includes a processing unit, such as CPU 402, a system memory 404 and an input output (I/O) system, generally 406. These various components are interconnected by system bus 408 which may be any of a variety of bus architectures. System memory 404 may include both non-volatile read only memory (ROM) 403 and volatile memory such as static or dynamic random access memory (RAM) 405. Programmable read only memories (PROMs), erasable programmable read only memories (EPROMs) or electronically erasable programmable read only memories (EEPROMs) may be provided. ROM portion 403 stores a basic input/output system (BIOS) as shown. RAM portion 405 can store the OS (preferably having the necessary relaying-related LKMs and network stacks), data, and/or programs. Computer system 400 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 410. Such devices may, for example, include a permanent storage device in the form of a large-capacity hard disk drive 412 which is connected to the system bus 408 by a hard disk drive interface 414. An optical disk drive 416 for use with a removable optical disk 417 such as a CD-ROM, DVD-ROM or other optical media, may also be provided and interfaced to system bus 408 by an associated optical disk drive interface 418. Computer system 400 may also have one or more magnetic disk drives 420 for receiving removable storage such as a floppy disk or other magnetic media 422 which itself is connected to system bus 408 via magnetic disk drive interface 424. Remote storage over a network is also contemplated.

System 400 is adapted to communicate with a data distribution network (e.g., LAN, WAN, the Internet, etc.) via communication link(s). Establishing the network communication is aided by one or more network device(s) interface(s) 426, such as a network interface card (NIC), a modem or the like which is suitably adapted for connection to the system bus 408. System 400 preferably also operates with various input and output devices as part of I/O system 406. For example, user commands or other input data may be provided by any of a variety of known types of input device and associated system bus interfaces, generally 428. One or more output devices with associated system bus interfaces, generally 430, may also be provided. A monitor or other suitable display device and its suitable adapter, generally 432, may also be connected to the system bus 408.

One or more of the memory or storage regions mentioned above may comprise suitable media for storing programming code, data structures, computer-readable instructions or other data types for the computer system 400. Such information is then executable by processor 402 so that the computer system 400 can be configured to embody aspects of the present invention. Alternatively, the software may be distributed over an appropriate communications interface so that it can be installed on the user's computer system.

Although certain aspects for the various participant computer systems may be preferred in the illustrative embodiments, the present invention should not be unduly limited as to the type of computers on which it runs, and it should be readily understood that the present invention indeed contemplates use in conjunction with any appropriate network communications device having the capability of being configured in a manner for accommodating the invention. Moreover, it should be recognized that the invention could be adapted for use on computers other than general purpose computers, as well as on general purpose computers without conventional operating systems.

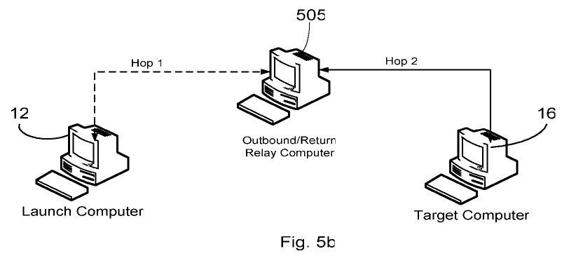

FIGS. 5a and 5b which illustrate two possible configurations for a relay system (as generally introduced in FIG. 1), and the presence of relay packets used therein. In the relay system 50 of FIG. 5a, a relay subnet 52 is provided which incorporates two relay computers 54 and 56 for both the outbound and return relay packets. Thus, relay hops 58, 510 and 512 are defined between the various participating computer systems. A relay network can, thus, be considered to include the relay subnet and the launch computer 12, and optionally the target computer 16 as well. Data requests issued by launch computer 12 are sent to the target computer 16 along a predetermined first relay route such that they travel from left to right in FIG. 5a through relay computers 54 and 56. Reply packets from target computer 16 toward the launch computer 12 travel from right to left in FIG. 5a along a predetermined second relay route, such that they pass through relay computer 56 and then relay computer 54 before reaching launch computer 12. As such, the diagram in FIG. 5a represents a situation where the relay computers for the outbound relay subnet are the same as those for the return relay subnet, although the ordinarily skilled artisan will readily appreciate that this does not have to be the case and that systems can be designed with one or more computers for both the outbound and return relay subnets, with even some overlap therebetween.

In any event, in the representative diagrammatic view of FIG. 5a, relay computer 54 can be regarded as both an initial outbound relay computer for purposes of outbound traffic from the launch to the target, and a terminal return relay computer for purposes of reply communications from the target toward the launch. Similarly, relay computer 56 can be regarded as a terminal computer for purposes of outbound relay packets and an initial computer for purposes of reply communications. During both outbound and return communications in accordance with the relay protocol described in below greater detail, relay-related packets, whether original or modified, travel along hops 58 and 510 and are indicated by dashed lines. As will be appreciated, relay-related packets for outbound and return communications along hop 512 are devoid of routing information. However, the artisan will recognize that those packets transmitted along hop 512 are nonetheless derived from data requests from the launch computer and data replies from the target computer and would not be present otherwise. Furthermore, while FIG. 5a identifies 58 as “hop 1”, 510 as “hop 2” and 512 “hop 3”, these numerical designations correlate to the ordering of hops for outbound relay traffic, which order would be reversed in FIG. 5a for return relay traffic. FIG. 5b is similar to FIG. 5a except, here, only a single relay computer 505 is employed in the relay network.

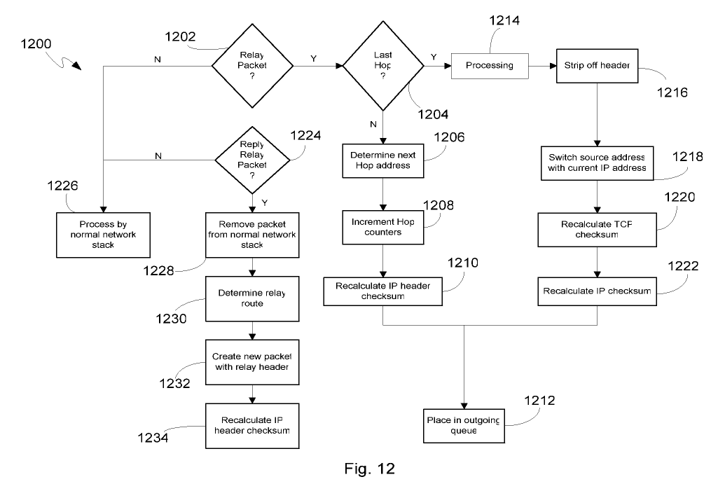

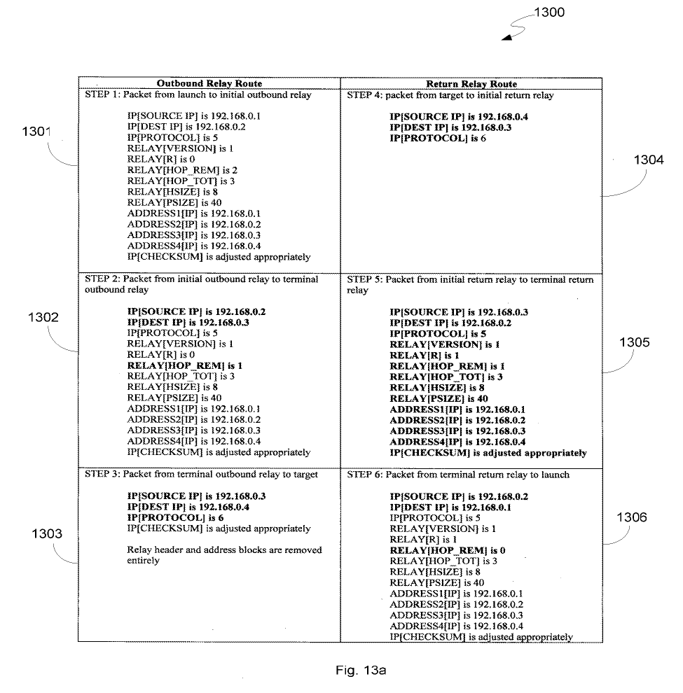

It is preferred that the relay subnet send the outbound relay packets to the target computer in a manner which does not reveal the launch computer as the originator of the outbound packets. Instead, the target computer is led to believe that the terminal outbound relay computer is the actual source of the outbound relay packets. With respect to return relay packets sent from the target computer to an initial return relay computer, such as relay computer 56 in FIG. 5a, these arrive at the launch computer with an indication that they are from the target computer, as opposed to the terminal return relay computer. Reference is made initially to the packet transition diagram 60 in FIG. 12 to introduce these capabilities. During outbound transmissions, launch computer 12 converts an outgoing packet 62 having the data request into an outbound relay packet 64 which incorporates outbound relay routing information. This conversion is accomplished by the launch computer's relay launch module which intercepts the packet as it proceeds down the network stack. The outbound relay packet 64 is then sent to the outbound relay subnet 66 and emerges as a modified outbound relay packet 68 having altered (in this case, removed) outbound routing information. Instead, the source data field for the emerging packet refers to the terminal outbound relay computer. As such, when the modified outbound relay packet 68 arrives at the target computer, it does so in a manner which does not reveal the identity of the launch computer as the packet's origin.

Target computer 16 thereafter transmits a return relay packet 610 to the return relay subnet 612. Return relay packet 610 incorporates the reply data which was gathered by the LKM installed on the target computer 16. More particularly, in the situation of a relay network configured as shown in FIG. 1, target computer 16 transmits the return relay packet 610 to an initial return relay computer which is physically the same as the terminal outbound relay computer. A modified return relay packet 614 emerges from the return relay subnet 612. This packet is considered to be modified in the sense that various ones of its data fields were necessarily altered in route in order for it to ultimately arrive at the launch computer 12. As modified return relay packet 614 reaches the target computer it is intercepted by the target computer's relay module as it passes up the network protocol stack, as described in below figures, in order to adjust the routing information such that the target computer 12 is identified as the source of the packet instead of the terminal return relay computer. As such, the launch computer recognizes it as the reply to its earlier outbound transmission.

It is preferred in the various embodiments that the launch computer be the only one which is witting of the relaying operation. The launch computer runs the software which packages and unpackages relay packets. The software is configured via a configuration file which determines if the packet is destined to a computer on the outbound relay list. The configuration file also lays out the outbound relay route that the packet will take. An example configuration file might include:

192.168.0.4:0=192.168.0.3:0+192.168.0.2:0+192.168.0.4:0

192.168.0.14:0=192.168.0.13:0+192.168.0.14:0

This tells the computer to send all packets addressed to 192.168.0.4 through the relay network via 192.168.0.3 then 192.168.0.2. It also instructs the launch computer to transmit packets destined to 192.168.0.14 through the relay network via 192.168.0.13. These IP addresses are, of course, for illustrative purposes only.

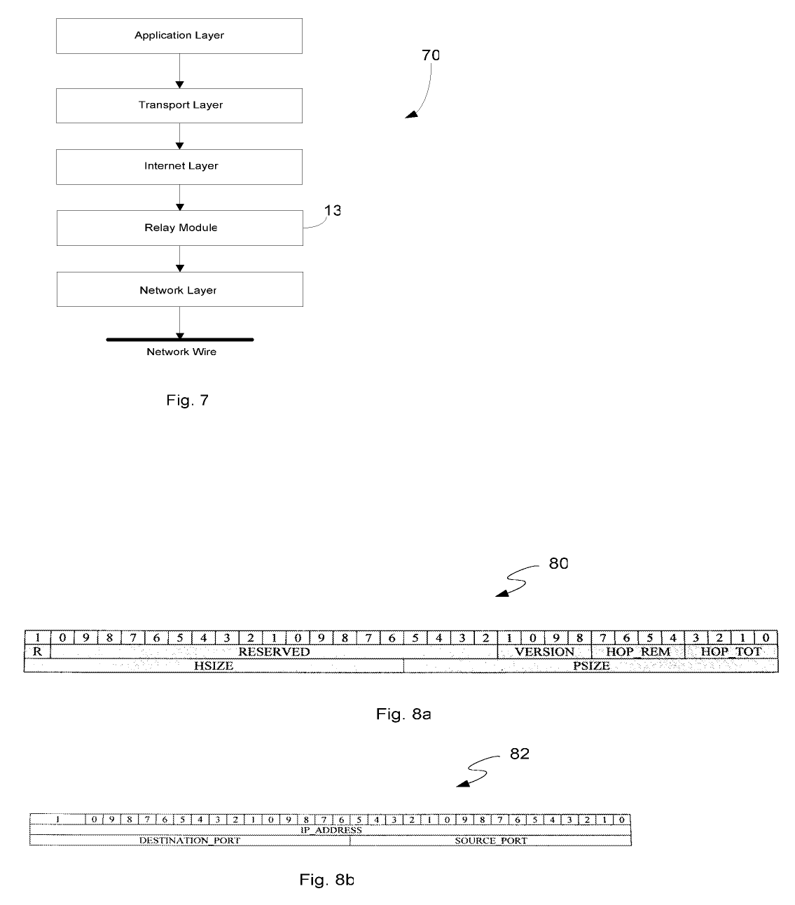

As a user connects to other machines the relay system examines the outgoing packets and, if the destination is on the relay list, the packet is altered to fit the relay specifications as described below. The relay launch module for accomplishing this may be inserted into the launch computer's OS, and in the case of a Unix implementation, via the usual insmod utility. The kernel module uses the Netfilter functionality to insert itself into the TCP/IP protocol stack 70, as depicted by the relay launch module 13 in FIG. 7. As part of the kernel module's initial start up procedures, the configuration file is processed to identify which destination IP addresses the outbound relay packets will be sent to, and the predetermined outbound relay route they will take. Once installed, packets sent to the selected IP addresses are wrapped prior to transmission to the outbound relay subnet.

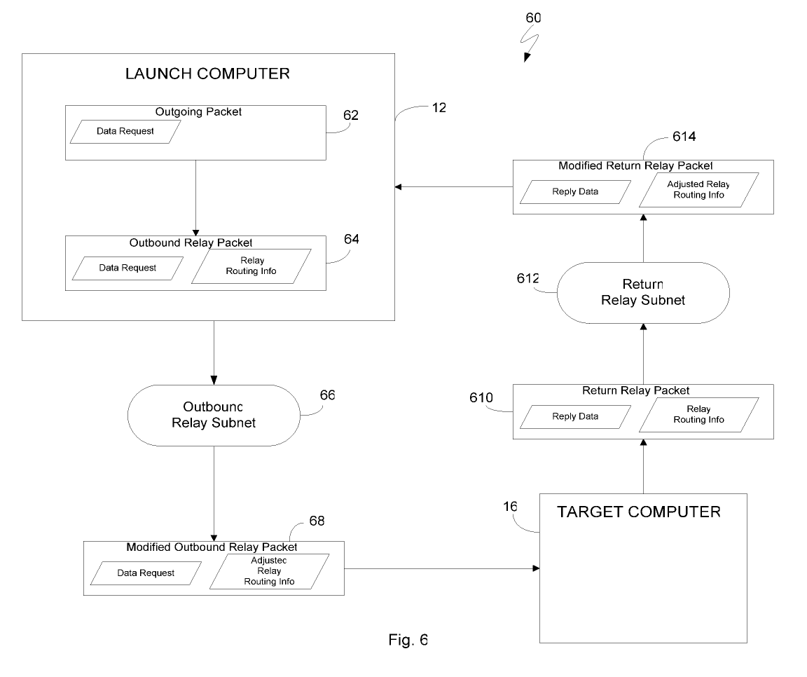

For outgoing packets which are on the destination list, the kernel module hooks into the outgoing TCP/IP stack using the Netfilter driver, allowing the modification of the packets as they depart from and arrive at the launch computer. As each packet is being constructed by the OS kernel and placed into the transmit queue, it is examined by the relay module to determine if it needs to be wrapped according to the relay protocol. That is, in order to traverse the relay network, an outgoing packet must be altered to include the routing information, as represented in FIG. 6, which indicates how the individual packet will be routed through the relay network in order to ultimately arrive at the target computer. The ordinarily skilled artisan will appreciate that the outbound relay packet must go through several steps in order to be sent through the relay network. For example, it must be enlarged to accommodate a relay header which must be built and inserted into the packet. The packet must also be marked as a relay packet, and the IP header checksum recalculated.

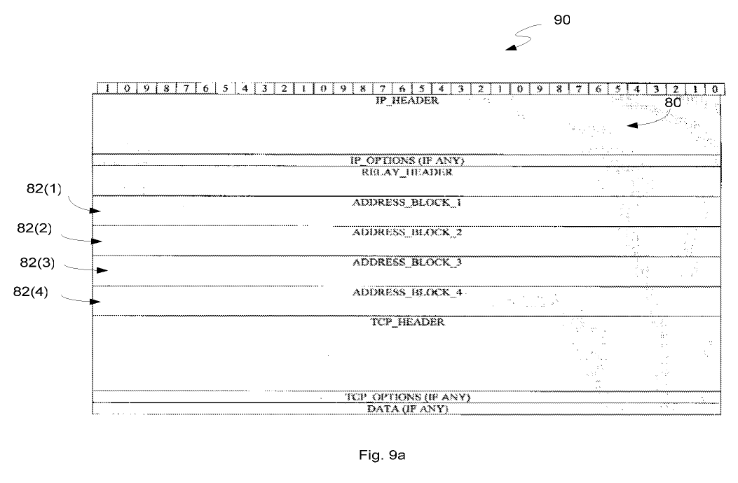

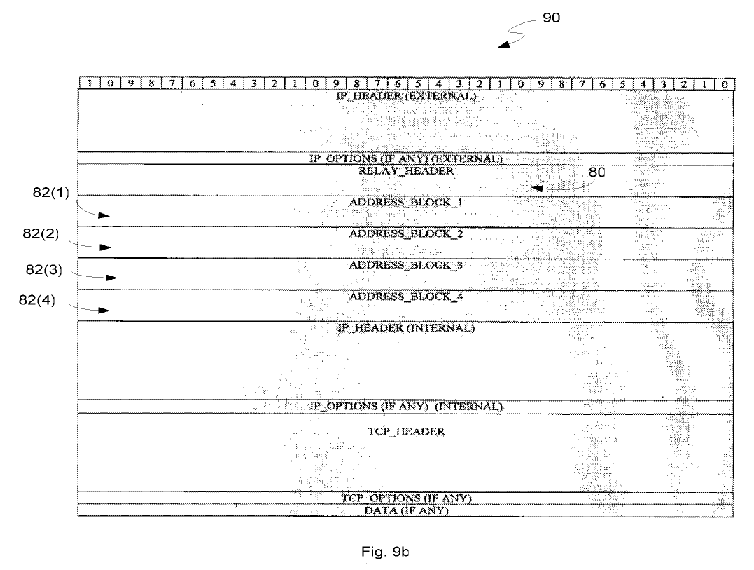

A representative relay header 80 is shown in FIG. 8a with it being understood that the least significant bit (LSB) is rightmost and the most significant bit (MSB) is leftmost. The relay header 80 is inserted into an outgoing packet and contains all of the information which the relay nodes need to route the outbound packets through the outbound relay subnet. The various fields for the relay header 80 are explained below:

Header Portion

| | |
|---|---|
| R: | return bit (0 = forward path, 1 = return path) |
| VERSION: | relay version |
| HOP_REM: | hops remaining in relaying |
| HOP_TOT: | hops total in route |
| PSIZE: | this relay header's size |
| HSIZE: | this relay header's size + the address data |
| | following it |

Address Block(s) portion

| | |
|---|---|
| IP ADDRESS: | the IP address for this hop |
| SOURCE_PORT: | the source port of this hop |
| DESTINATION_PORT: | the destination port of this hop |

Since hop_tot is the total number of hops the packet will take, this allows the packets to take a different number of hops between the launch and target systems. The hop_rem is decremented as the packet travels from node to node. The version field is provided to allow the software to be used later for compatibility issues. In the current implementation, the reserved flags are not being used. FIG. 8b represents a single address block portion 82 for a relay header. Each address structure 820, as shown, includes an IP Internet protocol address field, a destination port field and a source port field.

Two approaches have been contemplated for marrying a relay header and its one or more address blocks into an IP datagram. One approach is shown in FIG. 9a which depicts an encapsulated relay packet 90. This version “injects” the relay header 80 in the original outgoing packet immediately before the TCP header and following the IP header (or IP header options, if any). Some modification of certain parts of the IP header are needed in this version to accurately identify it as part of the relay protocol, for example, by setting the IP protocol field to “5”. A second encapsulated packet version 90′ is depicted in FIG. 9b. This version leaves the original outgoing packet data entirely intact; instead, it appends a new, external IP header, the relay header 80 and the address blocks 82(1)-82(4) at the beginning of the packet.

Currently, the relay module is adapted for use on computers running the Solaris and Linux operating systems. It will particularly work on Solaris 7, Solaris 8, Solaris 9, Linux 2.4.x and 2.6.x kernel series. To insert the header into an outgoing packet, the skb_copy_expand (<linux/skbuff.h>) function call can be used which copies the original packet over and introduces the requested extra space. Once the correct packet size is created, the information is copied over. The relay header is copied into the buffer. The IP header checksum is calculated using the updated information. Once this is completed, the packet is placed, the original packet is deleted, and the new packet is inserted into the transmit queue. This will send the relay packet to the initial outbound relay computer on the outbound relay subnet.

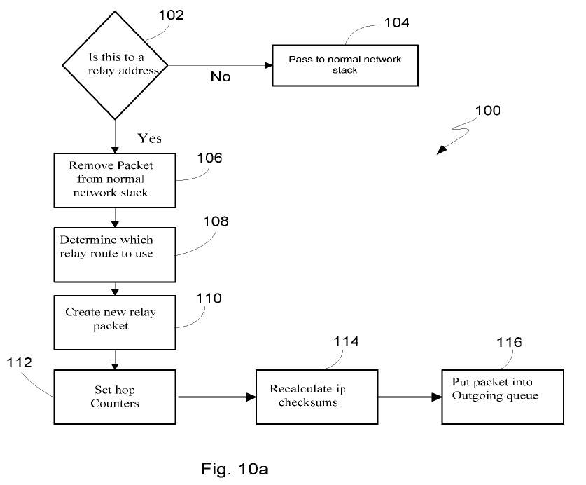

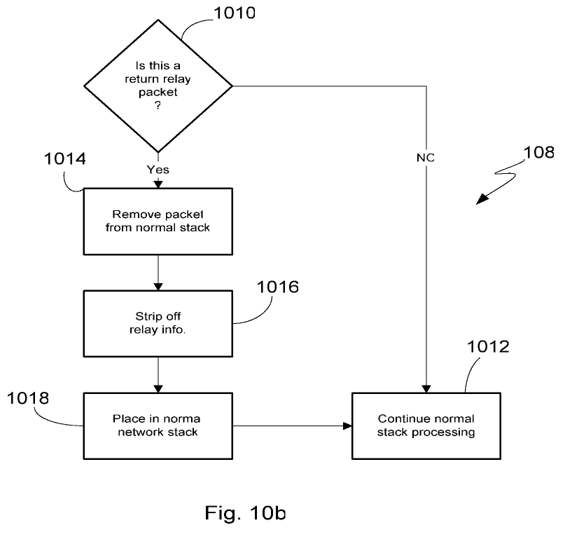

A decision-making flowchart for the outbound protocol stack of the launch computer is shown as 100 in FIG. 10a. A determination is made at 102 as to whether the outgoing packet is destined for a relay address within the configuration file's relay list. If not, the outgoing packet is allowed to pass to the normal network stack at 104. Otherwise, the outgoing packet is intercepted and removed from the normal network stack at 106 and a determination is made at 108 as to which relay route to use. It is, thus, contemplated that the configuration file may store a plurality of outbound relay routes given that a plurality of target computers might be of interest. Once the particular outbound relay route is ascertained, a new relay packet is created at 110 and the hop counters are set at 112 to the number of relay nodes to be used. This enables each relay node to determine if it is an end relay node. IP checksums are recalculated at 114 and the relay packet is then placed into the outgoing queue of the network stack at 116.

The launch computer also has the responsibility of examining all incoming packets to ascertain whether they are, in fact, return relay packets. Once identification of a return relay packet is made, the launch computer's kernel module will preprocess the packet before sending it up the TCP/IP network stack. The reason for the alteration of the packet is that the process which is expecting a return packet, expects the return packet to be from the target computer's IP, not the IP of the terminal return relay computer. Thus, the return relay packet's source IP is changed to be that of the target computer's IP address. The data in the return relay packet is copied up over the relay header to remove the relay header from the packet. The IP length is modified to correct the length and the header checksum is recalculated. Then, the packet is allowed to continue up the protocol stack according to normal IP functions. This allows the launch computer's applications to be unaware that they are utilizing the relay network. Thus, any application using TCP can seamlessly use the relay network with no extra configuration required on a per application basis.

Accordingly, FIG. 10b shows the decision-making 108 which takes place for incoming packets on the launch computer. If a determination is made at 1010 that the incoming packet is not a return relay packet, then it is passed at 1012 to the normal network stack for continued processing. However, if the incoming packet is a return relay packet, it is intercepted and removed from the normal network stack at 1014 and has its relay information stripped off at 1016. Thereafter, the incoming packet (i.e., the return relay packet) is placed back in the network stack at 1018 for further processing at 1012.

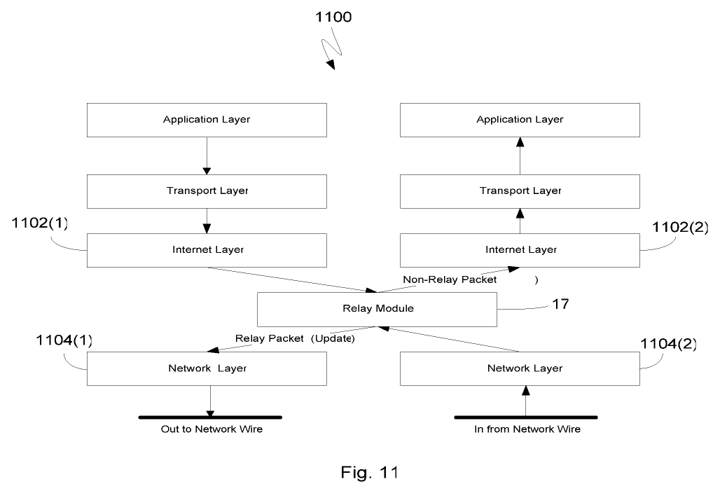

Reference is now made to FIGS. 11 and 12 to describe what transpires at the relay computers. The various relay computers may have the same software installed, although initial and terminal relay computers within the relay subnets function differently than others. A global relay module, however, can be configured to allow a given relay computer to function in either mode. When a relay computer is functioning purely as a relay (i.e., not an end node) it takes inbound relay packets and forwards them to the next relay node. However, when it is functioning as an end point, the node must deal with wrapping and unwrapping of the packets.

The relay module may be suitable installed on a relay computer and inserted into the network stack by the dev_add_pack (<linux/netdevice.h>) function. This allows the module to examine every packet before it is passed up the remainder of the stack, and insert packets into the stack. The module can then intercept packets from the stack and pull them off so that the normal network stack does not examine them. This prevents any other application, such as sniffers on the relay computer, from seeing the relay packets.

Each packet arriving at a relay computer/node is examined. If the packet is marked as a relay packet, for example, by having its IP protocol field designated in a manner which does not adhere to typical packets, then it is removed from the stack and processed by the relay module. The relay module examines the packet's relay header to determine if it is the last relay module, as well as what direction the relay packet is traveling. By checking the number of total hops versus hops taken, a decision is made as to whether this is the final hop along the route. When the packet is to be forwarded to another relay computer, the relay module increments the number of hops taken, looks in the relay header for the entry containing the information for the next hop, and retrieves the address of the next relay node. The relay module updates the addresses of the relay packet, as well as the IP header checksum. The new packet is then placed into the transmit queue and sent to the next node in the relay network.

FIG. 11 illustrates at 1100 the interaction of the relay module with the outbound and inbound network stacks of a relay computer which is not an end node. Relay module 17 hooks into the network stack between outbound Internet layer 1102(1) and network layer 1104(1), and between inbound Internet layer 1102(2) and network layer 1102(2).

As can be seen in FIG. 11, inbound packets from the network layer 1104(2) are intercepted by relay module 17. Those packets which are not relay packets are sent up the stack to Internet layer 1102(2). However, if they are relay packets they are diverted and redirected back to the network layer 1104(1) of the outbound stack. Suitable relay routing information is updated during this time. Outgoing packets proceeding down the network stack from Internet layer 1102(1) may be inspected by the relay module 17, but will simply continue down the outbound stack to the network layer 1104(1) without modification.

The launch computer and the terminal outbound relay computer are each responsible for unwrapping the packet according to the relay protocol. In addition, where the terminal outbound relay computer is also the initial return relay node it has the further responsibility of wrapping and forwarding each reply packet from the target computer. It must also keep track of packets which are sent out since the reply packets from the target computer will not have relay header information embedded in them.

With reference to the decision-making flowchart 1200 in FIG. 12, the terminal relay computer scans incoming packets at 1202 to ascertain if they are marked as relay packets. If the packet is a relay packet it is taken from the normal TCP/IP stack, preventing its detection by the host OS. The next step 1204 determines whether this is the last hop in the relay subnet. If not, the next hop address is determined at 1206, the hop counters are incremented at 1208 and the IP checksum is recalculated at 1210 before the packet is placed into the outgoing queue at 1212.

If, however, this is the last hop, corresponding to the relay computer being a terminal outbound relay computer, then the relay module performs some additional processing on the packet at 1214. Initially, the packet is examined to determine if it is a SYN packet since TCP packets are sent with the SYN flag set to start the standard three-way handshake that most protocols use to initiate connections. If the packet is a SYN packet, the relay module logs the connection to a linked list. The packet's destination IP address, port number and sequence number are logged, as well as the relay header. The relay header is kept so that response packets can be sent back to the originating computer. The relay header's addresses are preferably copied in reverse order so that all reply relay packets can just copy the header without needing to rearrange the packets. The linked list is searched to ensure there is not already an entry for the connection, which would be the case if there are matching sequence numbers and IP addresses. This needs to occur since most applications will send multiple SYN packets if no response is received. Once the connection information has been added to the linked list the packets must be corrected to be sent to the target computer.

After stripping off the header at 1216, the packet's source address is switched to be the current IP address at 1218. Preferably, this is accomplished by initially copying the IP destination address into the IP source address field. Then, the original destination address is copied into the IP destination address. This will properly address the packet, since the original source address was that of the launch machine. Then, the packet's data that follows the relay header is moved over the relay header. The packet is then set to the correct length and the TCP and IP checksums are recalculated at 1220 and 1222, respectively. Finally, by use of the ip_route_me_harder( ) (<linux/netfilter_ipv4.h>) and arp_find( ) (<net/arp.h>) functional calls, the MAC addresses for the destination computers are found. These are copied into the Ethernet header fields. Finally, the packet is placed into the outgoing queue at 1212 with the dev_queue_xmit( ) (<linux/netdevice.h>) function, which sends the packet to the target computer.

Another function of a terminal outbound relay computer is to properly send reply relay packets back through the relay subnet to the launch computer. The terminal node inspects each incoming packet at 1224 to determine if it is a reply packet. This is accomplished by checking the source port field of the TCP header with the destination port in the linked list. A proper reply packet's source port will match to the initiating packet's destination port. If there is no match, the packet is simply allowed at 1226 to be processed further up the network stack according to normal OS procedures. However, if there is a match, the packet must be sent through the relay subnet back to the launch computer. The packet is removed from the network stack at 1228 and a determination is made at 1230 as to which relay route to use. The packet is copied and the size expanded using the skb_copy_expand (<linux/netdevice.h>) call. Once a new packet is created with the appropriate space allocated, the IP header information is copied over from the old packet to the new packet. However, the end node's IP address is placed in the source address field so that the packet can be properly routed. Then, the relay header is copied into the packet, enabling the relay network to properly route the packet. After that, the proper MAC addresses are placed in the packet, which are determined as discussed above. At this point 1232, a new packet has been created with the appropriate relay header. Finally, the IP header checksum is recalculated at 1234 and the packet is placed in the outgoing queue at 1212. It can be appreciated from the above that a terminal outbound relay computer has the responsibility of much more processing than other relay computers, yet its operating system is still unwitting of the relay-related traffic.

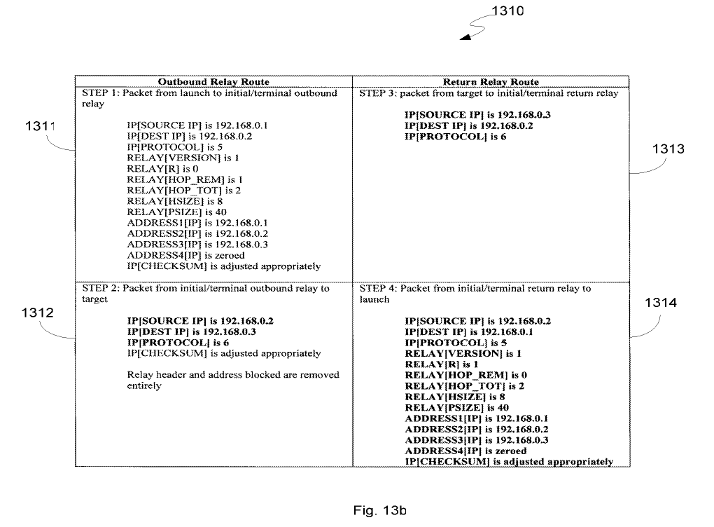

With an appreciation of the above description of the relay portion of the present invention, reference is now made to FIGS. 13a and 13b which illustrate in tabulated form packet state diagrams 1300 and 1310 for two representative relay networks such as those in FIGS. 5a and 5b above. In each of these packet state diagrams the left column relates to outbound relay-related packets from the launch computer toward the target computer, and the right column relates to return relay-related packets from the target computer toward the launch computer. Each row relates to a respective hop along a relay route. So, for example, steps 1301-1303 in FIG. 13a correspond to hops 1 to 3 in FIG. 5a, and steps 1304-1306 in FIG. 13a correspond to hops 3 to 1 in FIG. 5a. A similar interpretation follows for FIG. 13b as it relates back to FIG. 5b. In each of FIGS. 13a and 13b, the various fields for the relay headers are shown for each stage along either the outbound or return relay routes, with those fields whose data values have been changed relative to the preceding field being indicated in the figures by bold typeface for ease of understanding.

In FIG. 13a, four total computers are involved, again having representative addresses:

ADDRESS_BLOCK_1 = launch computer
ADDRESS_BLOCK_2 = 1^{st} relay computer
ADDRESS_BLOCK_3 = 2^{nd} relay computer
ADDRESS_BLOCK_4 = target computer

With initial reference to the outbound relay route column comprising steps 1301-1303, it is seen in step 1301 that the relay header, among other things, reflects all of the IP addresses for the computers within the outbound relay subnet. Since these are relay packets, the IP [protocol] field is designated by a suitable number, such as numeral 5, so that the operating systems on the various computers which see this designation will recognize such packets as relay-related packets. For non-relay related traffic, the packets would have a different IP [protocol] field destination such as the number 6. It may also be seen in the packets of steps 1302 and 1303 that they can be identified as outbound packets by the relay [R] flag “0”, while the packets for steps 1305 and 1306 have their relay flags set to “1”. Another field worth mention is the hop_rem field which is adjusted accordingly as the packets travel through the relay subnets. With specific reference to the packets corresponding to steps 1303 and 1304 it can be seen that, since these packets are encountered by the target computer, they do not contain information corresponding to the actual route taken. This effectively hides from the target computer's OS, and presumably its user(s), the fact that it is involved in a relay system.

Finally, the packet state diagram 1310 of FIG. 13b has only two steps 1311 and 1312 involved in the outbound relay route, and two steps 1313 and 1314 involved in the return relay route since this contemplates only a single relay computer involved in the communications. Similar interpretations for the various relay header fields of the packets for states 1311-1314 apply as with FIG. 13a so that they need not be discussed in further detail.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A relay system, comprising:
a. a first network communications device adapted to communicate according to a layered communications protocol that is characterized by a protocol stack, said first network communications device configured:
i. to send an outbound packet destined for a second network communications device such that the outbound packet is transmitted along a predetermined first relay route therebetween; and
ii. to receive a reply packet originating from the second network communications device, which reply packet is transmitted along a predetermined second relay route therebetween; and
b. a relay subnet defining the predetermined first and second relay routes, said relay subnet including at least one intermediary network communications device which forwards:
i. said outbound packet to the second network communications device without revealing said first communications device as the originator of the outbound packet; and
ii. said reply packet to said first network communications device.

2. A relay system for transmitting outbound packets via an outbound relay subnet along an outbound relay route and for transmitting reply packets via a return relay subnet along a return relay route, said relay system comprising:
a. a launch computer adapted to communicate according to a layered communications protocol that is characterized by a protocol stack, said launch computer configured:
i. for each respective outbound packet destined for a selected target computer, to incorporate into the outbound packet associated outbound routing information, prior to continued processing by the protocol stack;
ii. for each respective outbound packet not destined for the target computer, to allow said outbound packet to be normally processed by the protocol stack; for each respective inbound packet arriving from a relay computer along the return relay subnet, to convert the respective inbound packet into one which corresponds to a reply transmission from the target computer prior to continued processing by the protocol stack; and
iii. for each respective inbound packet arriving from a non-relay computer along the return relay subnet, to allow the respective relay packet to be normally processed by the protocol stack; and
b. at least one intermediary relay computer located along at least one of the outbound relay subnet and the return relay subnet, said intermediary relay computer adapted to communicate according to the layered communications protocol and configured:
i. for each respective outbound packet arriving from a preceding computer associated with the relay system, to either forward the respective outbound packet to a next outbound relay computer or the target computer; and
ii. for each respective reply packet arriving from a preceding computer along the return relay route, to either forward the respective return packet to a next return relay computer or said launch computer.

3. A relay system according to claim 2 including said target computer, and wherein said target computer has an associated target computer protocol stack and is configured:
a. for each respective outbound transmission packet arriving from a relay computer, to process said outbound packet by the target computer protocol stack; and
b. to transmit a reply packet to said relay computer.

4. A relay system according to claim 2 including a plurality of outbound relay computers, there being at least an initial outbound relay computer and terminal outbound relay computer.

5. A relay system according to claim 4 including a plurality of return relay computers, there being at least an initial return relay computer and a terminal return relay computer.

6. A method of transmitting data between computers, comprising:
a. creating, at a launch computer, an outbound packet having outbound routing information corresponding to a predetermined outbound relay route;
b. transmitting said outbound packet toward a target computer via a relay subnet defining the predetermined outbound relay route;
c. modifying the outbound packet during outbound transmission through the relay subnet to produce a modified outbound packet having altered outbound routing information which does not reveal the launch computer as an origin of said modified outbound packet;
d. receiving said modified outbound packet at the target computer;
e. creating, at the target computer, a reply packet in response to the modified outbound packet, wherein said reply packet incorporates return routing information;
f. transmitting said reply packet from the target computer to the relay subnet;
g. modifying the reply packet during transmission within the relay subnet to produce a modified reply packet having altered return routing information corresponding to a predetermined return relay route; and
h. sending said modified return transmission packet to the launch computer via the predetermined return relay route.

7. A method of transmitting data between computers, comprising:
a. sending an outbound transmission packet from a launch computer toward a target computer along an outbound relay route which includes at least one intermediary computer, whereby said target computer receives a modified outbound transmission packet which does not identify said launch computer as an origin of the modified outbound transmission packet; and
b. sending a reply transmission packet from the target computer to the intermediary computer, whereby said reply transmission packet is converted by the intermediary computer into a modified reply transmission packet and forwarded to the launch computer along a return relay route.

8. A method according to claim 7, further comprising:
a. with respect to each outbound communication from the launch computer to the target computer:
i. creating an outbound relay packet at the launch computer by embedding outbound routing information within an outgoing packet that is intended for the target computer;
ii. transmitting the outbound relay packet through an outbound relay subnet from an initial outbound relay computer to a terminal outbound relay computer;
iii. removing the outbound routing information at the terminal outbound relay computer and forwarding a modified outbound relay packet to the target computer whereby the target computer identifies the terminal outbound relay computer as the source of said modified outbound relay packet; and
b. with respect to each reply communication from the target computer:
i. receiving a reply transmission packet at an initial return relay computer and embedding return routing data within the reply transmission packet to create a return relay packet intended for the launch computer; and
ii. transmitting the return relay packet through a return relay subnet from the initial return relay computer to the launch computer for processing.

9. A network communications device configured for use as a participant in a relay system that includes a relay network comprising an outbound relay subnet and a return relay subnet, said network communications device comprising:
a. a memory storing an operating system which allows the network communications device to communicate with other computers on the relay network according to a layered communications protocol that is characterized by a protocol stack;
b. a storage device;
c. an I/O system including a network adapter for interfacing the network communications device to the relay network; and
d. a processor that is programmed:
i. with respect to each outbound packet destined for a selected target computer, to incorporate into the outbound packet associated outbound routing information during processing by the protocol stack;
ii. with respect to each outbound packet not destined for the target computer, to allow said outbound packet to be processed normally by the protocol stack;
iii. with respect to each inbound packet arriving from a relay computer along the return relay subnet, to convert the respective inbound packet into one corresponding to a reply transmission from the target computer during processing by the protocol stack; and
iv. with respect to each inbound packet arriving from a non-relay computer along the return relay subnet, to allow the respective inbound packet to be processed normally by the protocol stack.
